(19) United States
(12) Patent Application Publication
(10) Pub. No.: US 2014/0337650 A1
(43) Pub. Date: Nov. 13, 2014

(54) System and Method for Power Management in a Multiple-Initiator Storage System

(71) Applicant: LSI Corporation, San Jose, CA (US)

(72) Inventors: Naresh Madhusudana, Bangalore (IN); Naveen Krishnamurthy, Bangalore (IN); Kiran Math, Bangalore (IN); Karthik Nagesh, Bangalore (IN)

(21) Appl. No.: 13/927,826

(22) Filed: Jun. 26, 2013

(30) Foreign Application Priority Data
May 9, 2013 (IN) 530KOL2013

(51) Int. Cl. G06F 1/32

(52) U.S. Cl. CPC G06F 1/3234
USPC 713/323

(57) ABSTRACT

The disclosure is directed to a system and method for managing a plurality of storage devices. In an embodiment, at least one enclosure is configured to contain or support a plurality of storage devices accessible by a plurality of initiators. The enclosure further includes or is coupled to a power management controller in communication with the plurality of storage devices. The power management controller is configured to switch one or more storage devices of the plurality of storage devices from a first activity state to a second activity state when the one or more storage devices receive less than a selected number of data transfer requests over a specified time interval, where the one or more storage devices consume less power in the second activity state than in the first activity state.

### PRIORITY

The present application claims priority under 35 U.S.C. 119(b) to Indian Patent Application Serial No. 530/KOL/2013, entitled SYSTEM AND METHOD FOR POWER MANAGEMENT IN A MULTIPLE-INITIATOR STORAGE SYSTEM, By Naresh Madhusudana et al., filed May 9, 2013, which is currently co-pending, or is an application of which a currently co-pending application is entitled to the benefit of the filing date.

### FIELD OF INVENTION

The disclosure relates to the field of power management for multiple-initiator storage systems.

### BACKGROUND

Data storage systems often include a plurality of enclosures, each containing or supporting a plurality of storage devices, such as hard disk drives (HDDs). In a simple storage system, there is typically one initiator (e.g. server or host computing system) and several enclosures. In some more complex systems, multiple initiators are connected to the same set of enclosures with shared access to the respective storage devices of each enclosure. Power management is one of the technical challenges in the implementation of large scale storage topologies, which often include a very large number of initiators and enclosures. According to the current state of the art, storage devices in multiple-initiator storage systems are typically maintained in a high activity state (e.g. HDDs keep spinning) to avoid performance issues.

### SUMMARY

Various embodiments of the disclosure are directed to a system and method for managing a plurality of storage devices in a multiple-initiator data storage system to reduce overall power consumption. In an embodiment, one or more enclosures are configured to contain or support a plurality of storage devices which are accessible by a plurality of initiators. Each enclosure includes or is coupled to a power management controller in communication with the respective plurality of storage devices of the enclosure. The power management controller is configured to monitor data transfer requests (i.e. access by one or more of the initiators) occurring across the plurality of storage devices. The power management controller is further configured to switch one or more storage devices of the plurality of storage devices from a first activity state to a second (lower) activity state when the one or more storage devices receive less than a selected number of data transfer requests over a specified time interval. In some embodiments, power management is disabled or overridden for one or more storage devices according to a user specification or administrative command, the occurrence of a specified event, or in response to a request received from at least one initiator registered with the respective enclosure containing or supporting the one or more storage devices.

It is to be understood that both the foregoing general description and the following detailed description are not necessarily restrictive of the disclosure. The accompanying drawings, which are incorporated in and constitute a part of the specification, illustrate embodiments of the disclosure.

### BRIEF DESCRIPTION OF THE DRAWINGS

The embodiments of the disclosure may be better understood by those skilled in the art by reference to the accompanying figures in which:

FIG. 1 is a block diagram illustrating a multiple-initiator data storage system, in accordance with an embodiment of the disclosure;

FIG. 2 is a block diagram illustrating the data storage system, wherein at least one enclosure includes or is coupled to a power management controller for managing a plurality of storage devices of the enclosure, in accordance with an embodiment of the disclosure;

FIG. 3 is a flow diagram illustrating a method of managing a plurality of storage devices disposed within or supported by at least one enclosure, in accordance with an embodiment of the disclosure;

FIG. 4 is a flow diagram illustrating a method of managing a plurality of storage devices disposed within or supported by at least one enclosure, wherein at least one initiator is registered with the enclosure, in accordance with an embodiment of the disclosure;

FIG. 5 is a flow diagram illustrating a method of managing a plurality of storage devices disposed within or supported by at least one enclosure, wherein at least one initiator is registered with the enclosure, in accordance with an embodiment of the disclosure; and

FIG. 6 is a flow diagram illustrating a method of managing a plurality of storage devices disposed within or supported by at least one enclosure, in accordance with an embodiment of the disclosure.

### DETAILED DESCRIPTION

Reference will now be made in detail to the embodiments disclosed, which are illustrated in the accompanying drawings.

In a single-initiator storage system, the power management is done by the initiator, such as per T10 power management techniques. For example, particular storage devices are switched to a lower activity state (e.g. spun down or put in a low power mode) when there are reduced or no data transfers (IO activity) from the initiator. Doing so saves considerable amount of power and thus reduces the maintenance cost of the server.

In a multiple-initiator storage system, however, the initiators are often configured to operate independently of one another. As a result, each initiator lacks information regarding IO activity between the other initiators and shared storage devices. Power management typically needs to be disabled for all storage devices to make sure that certain storage devices are not put in a low activity state when there is reduced or no IO activity from just one of the initiators. Another situation can result when the initiators are powered down, such as when the server system goes to into sleep mode or hibernates. The initiators are often unable to send power management (e.g. spin down or power down) commands to every storage device. As a result, at least some of the storage devices may remain in a high activity state even though the overall system is inactive.

As the foregoing examples illustrate, storage devices in multiple-initiator storage systems are typically kept in a high activity state, thereby resulting in increased power consumption. The following embodiments are directed to a system and method of controlling the activity state, and hence power consumption, of a plurality of storage devices according to IO activity of each storage device. Accordingly, power management is provided for storage devices accessible by a plurality of initiators operating independent of one another.

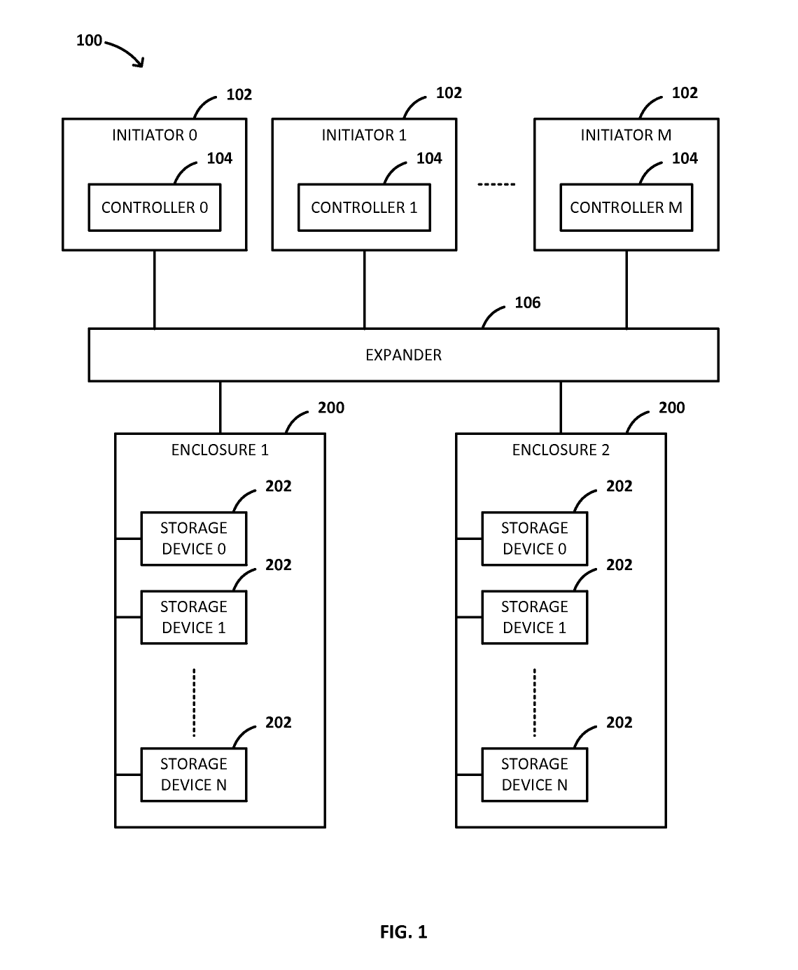

FIG. 1 illustrates an embodiment of a data storage system 100 including a plurality of initiators 102, such as servers or networked computing systems. Each initiator 102 includes at least one controller 104 such as, a RAID controller, RAID on Chip (ROC) controller, or at least one single-core or multiple-core processor. In some embodiments, the system 100 further include a plurality of enclosures 200, each containing or supporting a respective plurality of storage devices 202, such as SAS or SATA hard disk drives (HDDs). The initiators 102 are communicatively coupled to the one or more enclosures 200 of the system 100 for shared access to the plurality of storage devices 202. In some embodiments, the respective controller 104 of each initiator 102 is communicatively coupled to the enclosures 200 through an expander 106 or functionally equivalent wireless or wired networking switch.

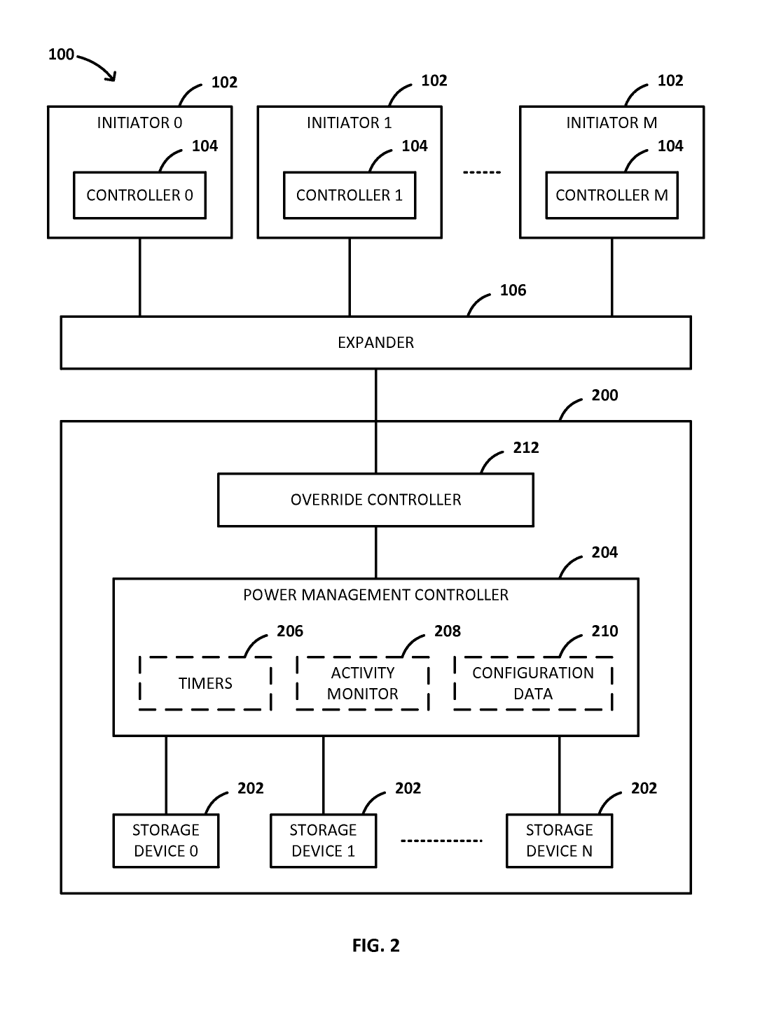

As shown in FIG. 2, each enclosure 200 includes or coupled to at least one power management controller 204. In some embodiments, the power management controller 204 includes at least one of a dedicated microcontroller, ASIC, or electronic circuit. In some embodiments, the power management controller 204 includes a software module executable by at least one processor from at least one carrier or storage medium. In some embodiments, the power management controller 204 includes various timers 206 and an activity monitor 208 enabling data links going to and from the storage devices to be monitored over specified time intervals. In some embodiments, the power management controller 204 further includes predetermined or user selected configuration data 210 for enabling/disabling power management control for one or more selected storage devices 202, selecting a particular type or mode of power management (e.g. T10 power management), and setting the various timers 206 (e.g. activity monitoring or spin down timers).

The power management controller 204 is configured to manage activity states, and hence power consumption, of the respective storage devices 202 of each enclosure 200 based upon data transfers (IO activity) going to or from each of the storage devices 202. When power management control is enabled, the power management controller 204 is configured to switch storage devices 202 receiving less than a selected number of data transfer requests over a specified time interval from a first (higher power consumption or operating) activity state to a second (lower power consumption) activity state. In some embodiments, the power management controller 204 is configured to spin down the idle storage devices 202 or put them into a low power, sleep, or standby mode. As such, the storage devices 202 are manageable at the enclosure level independent of initiator status.

In some embodiments, however, selected storage devices 202 are further managed according to commands, requests, or status associated with at least one of the initiators 102. According to such embodiments, each enclosure 200 further includes an override controller 212 configured to provide certain access controls to an initiator 102 registered with the enclosure 200. In some embodiments, the override controller 212 is configured to enable a registered initiator 102 to enable/disable power management for one or more selected (or registered) storage devices 202. In some embodiments, the override controller 212 is further configured to control selected storage devices to a user selected or predetermined activity state (e.g. storage devices are kept spinning or in a selected operating mode) when power management control is disabled according to a registered initiator 102 or an administrative command.

In some embodiments, the override controller 212 in each enclosure 200 is configured to enable the initiators 102 to register themselves with the enclosure 200 at power up of the initiator 102 or at power up of the enclosure 200. In some embodiments, each enclosure 200 is further configured to have power management control enabled for all storage devices 202 at startup. According to an administrative command or a request from a registered initiator 102, power management control is then selectively disabled for storage devices 202 which should not be spun down or switched to a low power mode regardless of the respective IO activity. In some embodiments, for example, power management control is disabled for storage devices storing an operating system (OS).

In some embodiments, the override controller 212 includes at least one of a dedicated microcontroller, ASIC, or electronic circuit. In some embodiments, the override controller 212 includes a software module executable by at least one processor from at least one carrier or storage medium. In some embodiments, the power management controller 204 and/or the override controller 212 are integrated with the enclosure 200, such as via a vendor specific SCSI enclosure services (SES) page or a special capability accessible by the initiators 102 utilizing vendor specific symmetrical multi-processing (SMP).

In some embodiments, an entry is made whenever an initiator 102 is registered, such as one bit entry per data link or phy of each storage device 202 registered with the initiator 102. This entry specifies whether power management control is enabled or disabled for each of the registered storage devices 202. In some embodiments, the initiator 102 is configured to make the entries via a vendor specific SES page write command or a vendor specific SMP command. In some embodiments, the entries are automatically removed when an initiator 102 is unregistered or powered down. Accordingly, power management control is automatically re-enabled for storage devices 202 that may have been disabled by the initiator 102.

In some embodiments, the power management control is enabled for all storage devices 202 of an enclosure 200 so long as no initiators 102 are registered with the enclosure 200. Accordingly, the power management controller 204 is configured to spin down or switch one or more storage devices 202 to a lower activity state when the one or more storage devices 202 are idle (i.e. receiving no data transfers) for a specified period of time. If one or more initiators 102 are registered with the enclosure, then power management control may be disabled for a selected storage device 202 according to commands received from the one or more initiators 102. Power management is re-enabled for the selected storage device 202 when the initiators 102 are all un-registered, disconnected, or shutdown. In some embodiments, power management is re-enabled for the selected storage device 202 when commands to re-enable power management are received from all registered initiators 102 that previously requested to disable power management via the override controller 212.

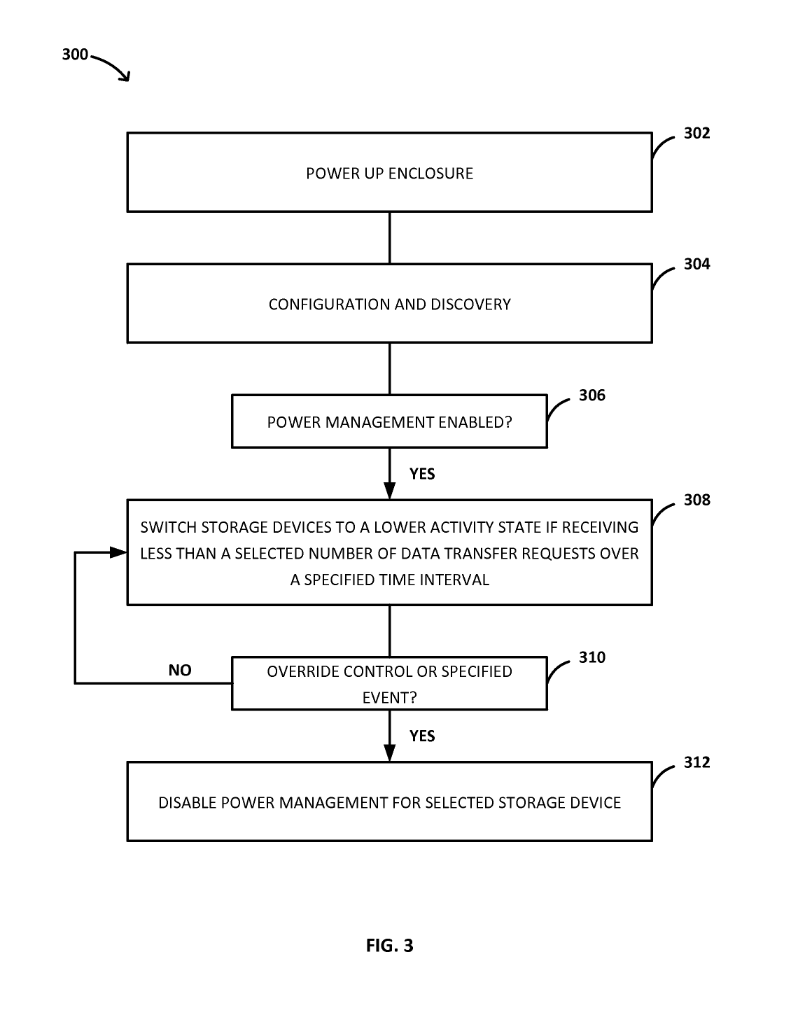

FIGS. 3 through 6 illustrate methods of managing the interactions between one or more initiators 102 and enclosures 200 of the system 100 to manage power consumption by the respective storage devices 202 of each enclosure 200. Further, it is recognized that one or more steps of methods 300, 400, 500, and 600 may be carried out via additional or alternative configurations beyond those described with regard to embodiments of system 100. Accordingly, the methods that follow are inclusive of any system or device configured to execute the following steps.

FIG. 3 illustrates a method 300 of operating an enclosure 200 to manage power consumption by the respective storage devices 202 of each enclosure 200, in accordance with an embodiment of this disclosure. At steps 302 and 304, the enclosure 200 completes discovery and self-configuration at power up. Accordingly, the storage devices 202 and configuration data 210 are accounted for.

At step 306, the power management controller 204 determines whether power management is enabled for each storage device 202. At step 308, for those storage devices with enabled power management control, the power management controller 204 is configured to monitor IO activity. Storage devices with receiving less than a selected number of data transfer requests or having no IO activity at all for a specified time interval are switched to a lower activity state.

At steps 310 and 312, the power management controller 204 continues to manage the storage devices 202 except for storage devices 202 that have power management control disabled as a result of override control according to a registered initiator or administrative command or as a result of a specified event, such as a system error or failure of another storage device 202.

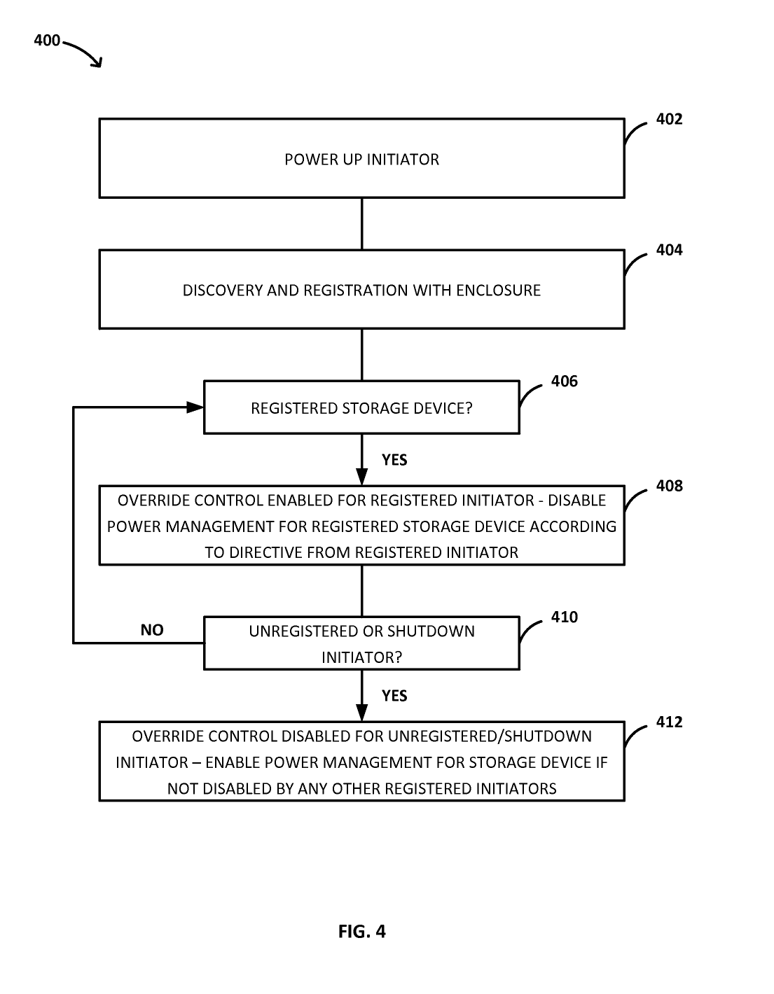

FIG. 4 illustrates a method 400 of operating an initiator 102 to manage power consumption by the respective storage devices 202 of a registered enclosure 200, in accordance with an embodiment of this disclosure. At steps 402 and 404, the initiator 102 completes discovery and registration with one or more enclosures 200 after powering up.

At steps 406 and 408, the initiator 102 is enabled to disable power management control via the override controller 212 for selected storage devices 406 which are (directly or indirectly) registered with the initiator 102. At steps 410 and 412, power management control is re-enabled for the selected storage devices 202 upon powering down or unregistering the initiator 102 and all other initiators 102 that are overriding power management control for the selected storage devices 202.

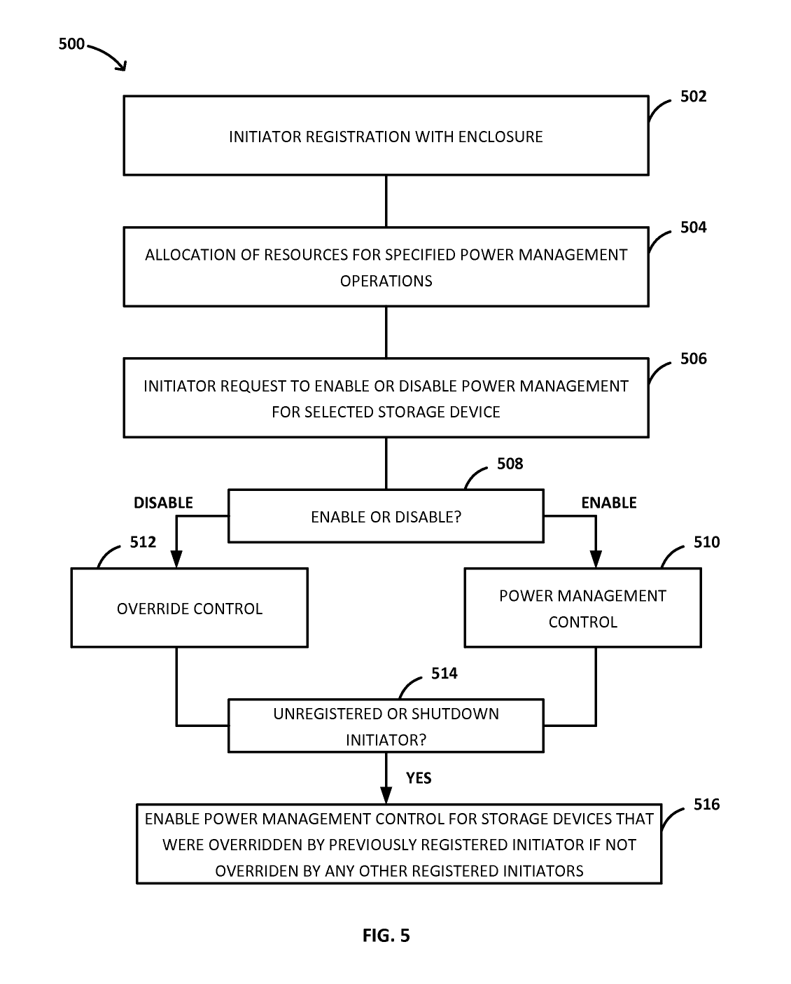

FIG. 5 illustrates a method 500 of operating an initiator 102 and a registered enclosure 200 to manage power consumption by the respective storage devices 202 of the registered enclosure 200, in accordance with an embodiment of this disclosure. At step 502, the initiator 102 is registered to the enclosure 200 according a registration request from the initiator 102.

At step 504, resources are allocated between the initiator 102 (via the override controller 212) and the enclosure 200 (via the power management controller 204) to enable management of the respective storage devices 202 of the enclosure 200. At step 506, the initiator 102 can override control, and hence disable power management, for selected storage devices 202. The initiator 102 is further enabled to return power management control for selected storage devices 202 via an enabling command or by unregistering itself from the enclosure 200.

At steps 508, 510, and 512, the selected storage devices 202 continue to operate under power management control or override control according at least one of a command, request, or status associated with the registered initiator 102. At steps 514 and 516, power management control is enabled for the selected storage devices 202 when the registered initiator or plurality of registered initiators that were overriding the storage devices 202 become unregistered or are powered down.

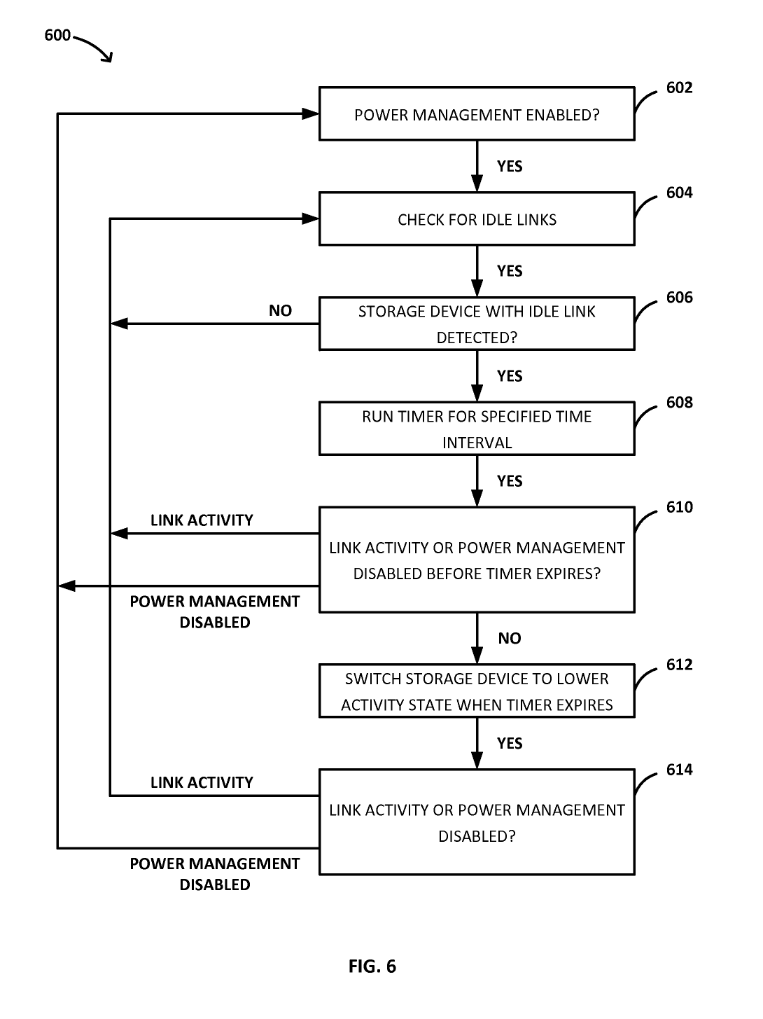

FIG. 6 illustrates of method 600 of managing the respective storage devices 202 of an enclosure 200 according to link activity associated with each storage device 202, in accordance with an embodiment of this disclosure. By managing the storage devices 202 according to the link activity, information regarding the particular one or more initiators 102 accessing the storage devices 202 is not required. When power management is enabled at step 602, the activity states (and hence power consumption) of the storage devices 202 can be controlled according to IO activity associated with each storage device 202.

At step 604, the power management controller 604 is configured to monitor links or phys of the storage devices 202 for reduced or no IO activity (i.e. idle links). At steps 606 and 608, the power management controller 604 is configured to start a timer 206 when a storage device 202 having an idle link is detected. The timer 206 is set to run for a specified period of time, during which the activity monitor 208 continues to check for IO activity (i.e. data transfers) going to or from the storage device 202.

At steps 610 and 612, the storage device 202 is switched to a lower activity state (i.e. spun down or put in a low power mode) if the activity monitor 208 does not detect IO activity before the timer expires. In some embodiments, however, the storage device 202 will remain in an operating or high activity state if power management is disabled while the timer is running. At step 614, the storage device 202 may be switched back from a low activity state to an operating or high activity state when IO activity is detected between the storage device 202 and an initiator 102 or as a result of power management being disabled or overridden.

It should be recognized that the various functions or steps described throughout the present disclosure may be carried out by any combination of hardware, software, or firmware. In some embodiments, various steps or functions are carried out by one or more of the following: electronic circuits, logic gates, field programmable gate arrays, multiplexers, or computing systems. A computing system may include, but is not limited to, a personal computing system, mainframe computing system, workstation, image computer, parallel processor, or any other device known in the art. In general, the term “computing system” is broadly defined to encompass any device having one or more processors, which execute instructions from a memory medium.

Program instructions implementing methods, such as those manifested by embodiments described herein, may be transmitted over or stored on carrier medium. The carrier medium may be a transmission medium, such as, but not limited to, a wire, cable, or wireless transmission link. The carrier medium may also include a storage medium such as, but not limited to, a read-only memory, a random access memory, a magnetic or optical disk, or a magnetic tape.

It is further contemplated that any embodiment of the disclosure manifested above as a system or method may include at least a portion of any other embodiment described herein. Those having skill in the art will appreciate that there are various embodiments by which systems and methods described herein can be effected, and that the implementation will vary with the context in which an embodiment of the disclosure deployed.

Furthermore, it is to be understood that the invention is defined by the appended claims. Although embodiments of this invention have been illustrated, it is apparent that various modifications may be made by those skilled in the art without departing from the scope and spirit of the disclosure.

What is claimed is:

1. A system for managing a plurality of storage devices, comprising:
a plurality of storage devices accessible by a plurality of initiators, wherein each storage device of the plurality of storage devices is configured to receive independent data transfer requests from at least a first initiator and a second initiator of the plurality of initiators; and
a power management controller in communication with the plurality of storage devices, the power management controller configured to switch one or more storage devices of the plurality of storage devices from a first activity state to a second activity state when the one or more storage devices receive less than a selected number of data transfer requests over a specified time interval, wherein the one or more storage devices consume less power in the second activity state than in the first activity state.

2. The system of claim 1, further comprising:
an enclosure configured to contain or support the plurality of storage devices.

3. The system of claim 2, the enclosure is further configured to contain or support the power management controller.

4. The system of claim 1, wherein the power management controller is configured to switch the one or more storage devices from the first activity state to the second activity state when the one or more storage devices do not receive any data transfer requests from the plurality of initiators during the specified time interval.

5. The system of claim 1, wherein at least one selected storage device is controlled to a selected activity state independent of the power management controller.

6. The system of claim 1, further comprising:
an override controller in communication with the plurality of initiators, the override controller configured to register at least one initiator of the plurality of initiators with at least one storage device of the plurality of storage devices.

7. The system of claim 6, wherein the at least one registered storage device is controlled to a selected activity state associated with the at least one registered initiator.

8. A data storage system, comprising:
a plurality of initiators;
a plurality of enclosures, each enclosure containing or supporting a plurality of storage devices accessible by the plurality of initiators, wherein each storage device of the plurality of storage devices is configured to receive independent data transfer requests from at least a first initiator and a second initiator of the plurality of initiators; and
at least one power management controller disposed within or supported by at least one enclosure of the plurality of enclosures, the at least one power management controller configured to switch one or more storage devices of a respective plurality of storage devices of the at least one enclosure from a first activity state to a second activity state when the one or more storage devices receive less than a selected number of data transfer requests over a specified time interval, wherein the one or more storage devices consume less power in the second activity state than in the first activity state.

9. The data storage system of claim 8, wherein the plurality of initiators are disposed external to the at least one enclosure.

10. The data storage system of claim 8, wherein the plurality of initiators are configured to operate independent of one another.

11. The data storage system of claim 8, wherein the at least one power management controller is configured to switch the one or more storage devices from the first activity state to the second activity state when the one or more storage devices do not receive any data transfer requests from the plurality of initiators during the specified time interval.

12. The data storage system of claim 8, wherein at least one selected storage device is controlled to a selected activity state independent of the power management controller.

13. The data storage system of claim 8, further comprising:
at least one override controller disposed within or supported by the at least one enclosure; the at least one override controller configured to register at least one initiator of the plurality of initiators with at least one storage device of the respective plurality of storage devices of the at least one enclosure.

14. The data storage system of claim 13, wherein the at least one registered storage device is controlled to a selected activity state associated with the at least one registered initiator.

15. A method of managing a plurality of storage devices, comprising:
accessing a plurality of storage devices disposed within or supported by an enclosure utilizing a plurality of initiators, wherein each storage device of the plurality of storage devices is configured for receiving independent data transfer requests from at least a first initiator and a second initiator of the plurality of initiators; and
switching one or more storage devices of the plurality of storage devices from a first activity state to a second activity state when the one or more storage devices receive less than a selected number of data transfer requests over a specified time interval, wherein the one or more storage devices consume less power in the second activity state than in the first activity state.

16. The method of claim 15, wherein the one or more storage devices are switched from the first activity state to the second activity state utilizing a power management controller disposed within or supported by the enclosure.

17. The method of claim 15, wherein the one or more storage devices are switched from the first activity state to the second activity state when the one or more storage devices do not receive any data transfer requests from the plurality of initiators during the specified time interval.

18. The method of claim 15, further comprising:
registering at least one initiator of the plurality of initiators with at least one storage device of the plurality of storage devices.

19. The method of claim 18, further comprising:
controlling the at least one registered storage device to a selected activity state associated with the at least one registered initiator.

20. The method of claim 18, wherein the at least one initiator is registered with the at least one storage device utilizing an override controller disposed within or supported by the enclosure.
